(19) United States
(12) Patent Application Publication
(10) Pub. No.: US 2007/0155322 A1
(43) Pub. Date: Jul. 5, 2007

(54) Security methods for input device

(75) Inventors: Han-Che Wang, Shenzhen (CN); Kuan-Hong Hsieh, Shenzhen (CN); Wen-Chuan Lian, Shenzhen (CN); Xiao-Guang Li, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,894

(22) Filed: Oct. 19, 2006

(30) Foreign Application Priority Data
Dec. 19, 2005 (CN) 200510121019.2

(51) Int. Cl. H04B 1/06

(52) U.S. Cl. 455/26.1

(57) ABSTRACT

An input device is provided. The input device has a storage unit, a microcontroller, and a plurality of input units for generating operational inputs. The storage unit is for storing information, typically private, sensitive files/documents. Furthermore, when locked, the storage unit is not allowable for access. The microcontroller includes a password comparing module and an unlocking module. The password comparing module is for comparing the operational inputs from the input units with a predetermined password, and generating an unlock signal if the operational inputs match the predetermined password. The unlocking module is electrically connected to the password comparing module, and is configured for unlocking the storage unit in response to the unlock signal, thereby enabling a computer system connected thereto to access the storage unit. Related methods are also provided.

### TECHNICAL FIELD

The present invention relates to input devices and methods therewith, and particularly to an input device with a security system and a security method therewith.

### GENERAL BACKGROUND

Along with continual development of the information industry, computers have penetrated into everyday lives of people whether work related or personal related. Computer peripheral devices such as mice and memory devices have also become non-excludable products in computer operations.

When a user operates a computer to perform data processing, a mouse plays an important role when using a graphical user interface of the computer. Through an accurate cursor control provided by the mouse, the user can maneuver information on the screen performing actions such as, selection, drag, and execution, thereby performing data editing, data cutting or pasting, documents opening or closing, and so on.

In an unrelated aspect, it is also necessary to store various kinds of electronic data in peripheral devices. Therefore, data storage devices such as flash memories, electronic erasable programmable read-only memories (EEPROMs), or magnetic recording media were developed to store the various kinds of electronic data. For example, various kinds of memory cards allow users be able to conveniently exchange various kinds of files and documents between computers.

However, in prior arts, the cursor function of the mouse and the data storage function of the memory belong to separate peripheral devices. Nevertheless, the independent nature of these two functions may be troublesome to people, typically someone who is often out of home or office. When people are out, they are required to carry many computer peripheral devices associated with a portable computer such as, for example, the mouse, the data storage device, and the like. As a result, the more computer peripheral devices needed, the higher possibility people may forget to bring the peripheral devices. In other words, the separation of a mouse function and a storage function creates many inconveniences for people.

Therefore, a mouse capable of storing data, namely a combination of the conventional mouse and the conventional data storage device, has been introduced recently. This mouse can be used for data access when being used as a regular mouse. While this mouse is capable of precluding the above problem in portability, another problem has been encountered that, data stored in the mouse, that are mostly are private and sensitive information, however, has no mechanism to method to prevent unauthorized access to the data.

What is needed, therefore, is an input device and security methods therewith, which is capable of preventing unauthorized access to the input device.

### SUMMARY

An input device is provided. The input device has a storage unit, a coordinate output circuit, a microcontroller, and a plurality of input units. The storage unit is for storing information. When locked, the storage unit is not allowable for access, and vice versa. The coordinate output circuit is for generating coordinate inputs. The input units are for generating operational inputs. The microcontroller is for outputting the coordinate inputs from the coordinate output circuit to a computer system connected thereto. The microcontroller further includes a password comparing module and an unlocking module. The password comparing module is for comparing the operational inputs from the input units with a predetermined password, and generating an unlock signal if the operational inputs match the predetermined password. The unlocking module is for unlocking the storage unit, thereby enabling the computer system to access the information of the storage unit.

A security method used in an input device is also provided, wherein the input device has a storage unit, a coordinate output circuit for generating coordinate inputs, and a plurality of input units for generating operational inputs. The method includes the steps of: (a) outputting the coordinate inputs from the coordinate output circuit to a computer system connected thereto; (b) comparing the operational inputs with a predetermined password if the storage unit is locked thereby unallowable for access; (c) generating an unlock signal if the operational inputs match the predetermined password; and (d) unlocking the locked storage unit according to the unlock signal thereby enabling the computer system to access the storage unit.

Another security method used in an input device is further provided, wherein the input device has a storage unit, a coordinate output circuit for generating coordinate inputs, and a plurality of input units for generating operational inputs. The method includes the steps of: (a) outputting the coordinate inputs from the coordinate output circuit to a computer system connected thereto; (b) comparing the operational inputs with a predetermined password if the coordinate inputs match a coordinate of the storage unit and the storage unit is locked thereby unallowable for access; (c) generating an unlock signal if the operational inputs match the predetermined password; and (d) unlocking the locked storage unit according to the unlock signal thereby enabling the computer system to access the storage unit.

Other advantages and novel features will be drawn from the following detailed description with reference to the attached drawing, in which:

### BRIEF DESCRIPTION OF DRAWINGS

FIG. 1 is an exemplary schematic diagram of a hardware infrastructure of an input device having a security system in accordance with a preferred embodiment of the present invention;

FIG. 2 is a flowchart of a first preferred method for unlocking a storage unit of the input device of FIG. 1; and

FIG. 3 is a flowchart of a second preferred method for unlocking the storage unit of the input device of FIG. 1.

### DETAILED DESCRIPTION

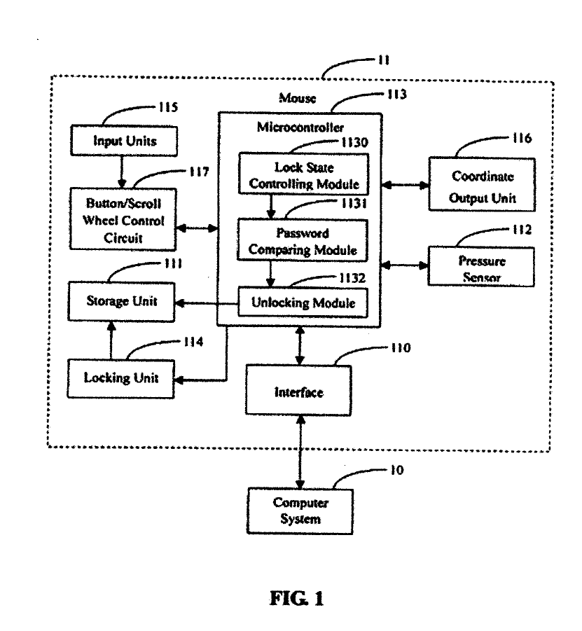

FIG. 1 is an exemplary schematic diagram of a hardware infrastructure of an input device in accordance with a preferred embodiment of the present invention. The input device 11 is a peripheral device, typically a pointing device such as, for example, a mouse, a joy stick, a track ball, etc, which not only enables control of a cursor on a display of a computer system 10 connected thereto, but can also store data. Furthermore, the input device 11 is configured with a security system therein for preventing unauthorized access to the stored data.

In this exemplary embodiment, the mouse is provided as an example. The mouse 11 has an interface 110, a storage unit 111, a pressure sensor 112, a microcontroller 113, a locking unit 114, a plurality of input units 115, a coordinate output unit 116, and a button/scroll wheel control circuit 117.

The interface 110 is for performing data communication between the mouse 11 and the computer system 10. Consequently, the interface 110 can be any appropriate communication media such as, for example, a Universal Serial Bus (USB) interface, a PS/2 (Personal System/2) interface, and so on.

The storage unit 111 is for storing information. The information includes various kinds data, typically private files/documents.

The input units 115 are for operational inputs. In this exemplary embodiment, the input units 115 are configured as a left button, a middle button, and a right button, as well as a regular mouse has.

The coordinate output unit 116 is for outputting coordinates corresponding to a movement of the mouse 11 to the microcontroller 113, and the microcontroller 113 thereupon transmits the coordinates to the computer system 10 through the interface 110.

The button/scroll wheel control circuit 117 is for generating input signals to the microcontroller 113 corresponding to operational inputs on the buttons 115 or on a scroll wheel (not shown). In this exemplary embodiment as shown in FIG. 1, the button/scroll wheel control circuit 117 is in a form of an integrated circuit. However, in other cases, the button/scroll wheel control circuit 117 can be divided into two independent circuits, i.e., a button control circuit and a scroll wheel control circuit, each for processing corresponding operational inputs on the buttons 115 or the scroll wheel respectively.

The pressure sensor 112 is preferably configured at the bottom of the mouse 11 for sensing pressure thereon. Accordingly, the pressure sensor 112 is able to generate pressure sensing signals if the mouse 11 is kept flatwise on a support surface, whereas, the pressure sensor 112 does not generate the pressure sensing signals if the mouse 11 is not kept flatwise on the support surface. For example, if the mouse 11 is placed sideways or is in an overturned state, the pressure sensor 112 is not pressed, thus not generating the pressure sensing signals.

The microcontroller 113 scans the pressure sensing signals from the pressure sensor 112 in real time. In this exemplary embodiment, if a duration of not detecting the pressure sensing signals reaches a predetermined value, the microcontroller 113 generates and transmits a lock signal to the locking unit 114. After receiving the lock signal, the locking unit 114 performs a lock operation on the storage unit 111, thereby preventing unauthorized access to the storage unit 111.

Therefore, a user of the mouse 11 can promptly and conveniently lock the storage unit 111 through a simple operation on the mouse 11 such as, for example, turning over the mouse 11 or placing the mouse 11 sideways.

The microcontroller 113 further includes a lock state controlling module 1130, a password comparing module 1131, and an unlocking module 1132.

In a first preferred embodiment, when transmitting the lock signal to the locking unit 114, the microcontroller 113 simultaneously enables the lock state controlling module 1130. In other words, when the storage unit 111 is locked, the lock state controlling module 1130 is enabled. Accordingly, the microcontroller 113 immediately transmits the input signals received to the lock state controlling module 1130 until the storage unit 111 becomes unlocked. That is, before the storage unit 111 is unlocked, the input signals corresponding to the operational inputs on the buttons 115 are regarded as a password and transmitted to the password comparing module 1131 through the lock state controlling module 1130.

Thereupon, the password comparing module 1131 compares the input signals with a predetermined password, and generates an unlock signal if the input signals match the predetermined password. Therefore, the predetermined password can be in a form of input signals corresponding to one of the buttons 115 (i.e., the left button, the middle button, or the right button), or in a form of a combination of input signals corresponding to all the buttons 115.

After receiving the unlock signal, the unlocking module 1132 unlocks the storage unit 111, thereby enabling the computer system 10 to access the storage unit 111. Simultaneously, the lock state controlling module 1130 is disabled according to the unlock signal. Accordingly, the microcontroller 113 directly transmits the input signals received thereafter to the computer system 10 through the interface 110. In other words, after the storage unit 111 is unlocked, the input signals are regarded as normal input signals for normal operations and directly transmitted to the computer system 10.

Therefore, in the first embodiment, the input signals are used as a password before the storage unit 111 is unlocked. Consequently, if the input signals do not match the predetermined password, the operational inputs corresponding to the input signals are regarded as ineffective/irrelevant operations. In other words, the mouse 11 cannot be used for normal input operations before a correct password is entered, thereby preventing unauthorized access to the storage unit 111.

As compared to the first embodiment, in a second preferred embodiment, the microcontroller 113 enables the lock state controlling module 1131 when the storage unit 111 is locked and the computer system 10 is ready to access the storage unit 111 (namely, the coordinate of the currently movement of the mouse 11 corresponds to a coordinate of the storage unit 111). Accordingly, the microcontroller 113 transmits the input signals immediately received to the lock state controlling module 1130 when the computer system is ready to access the locked storage unit 111. That is, when the computer system is ready to access the locked storage unit 111, the input signals immediately received are regarded as a password for unlocking the storage unit 111 and transmitted to the password comparing module 1131 through the lock stated controlling module 1130.

Thereupon, the password comparing module 1131 and the unlocking module 1132 play the same role as done in the first embodiment respectively, and the lock state controlling module 1130 is also disabled according to the unlock signal. Similarly, after unlocking the storage unit 111, the microcontroller 113 directly transmits the input signals received thereafter to the computer system 10 through the interface 110. That is, the input signals received after the storage unit 111 is unlocked are regarded as normal input signals for normal operations and directly transmitted to the computer system 10.

In addition, in the second embodiment, the input signals are also regarded as normal input signals for normal operations and directly transmitted to the computer system 10 when the computer system is not ready to access the locked storage unit 111 (namely, the coordinate of the currently movement of the mouse 11 do not correspond to the coordinate of the storage unit 111).

Therefore, in the second embodiment, the input signals are used as a password when the storage unit 111 is locked and the computer system 10 is ready to access the storage unit 111, otherwise, the input signals are used as normal input signals. Consequently, the operational inputs corresponding to the input signals can be regarded as normal, effective operations except in the event that the computer system 10 is ready to access the locked storage unit 111 but the input signals immediately received do not match the predetermined password. In other words, the user can normally use the mouse 11 if not accessing the locked storage unit 111. If desiring access to the locked storage unit 111, the user has to enter a correct password first, otherwise, the user can not access the storage unit 111.

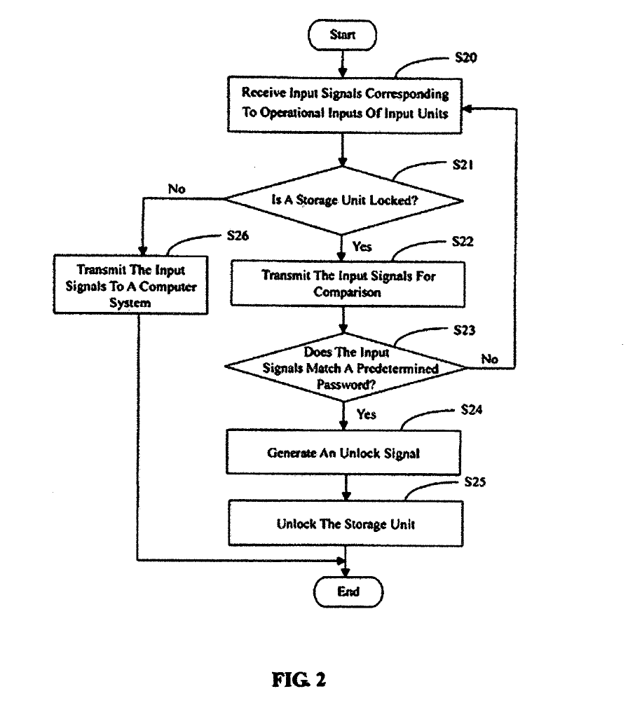

FIG. 2 is a flowchart of a first preferred method for unlocking the storage unit 111 of the input device 11 (i.e., the mouse 11) of FIG. 1. In step S20, the microcontroller 113 receives the input signals corresponding to the operational inputs on the input units 115 (i.e., the buttons). In step S21, the microcontroller 113 detects whether the storage unit 111 is locked.

If the storage unit 111 is locked, in step S22, the lock state controlling module 1130 transmits the input signals to the password comparing module 1131. In step S23, the password comparing module 1131 compares the input signals with the predetermined password. If the input signals do not match the predetermined password, the procedure thereupon returns to step S20 for receiving new input signals. If the input signals match the predetermined password, in step S24, the password comparing module 1131 generates and transmits the unlock signal to the unlocking module 1132. In step S25, the unlocking module 1132 unlocks the locked storage unit 111 and the lock state controlling module 1130 is disabled according to the unlock signal, thereby not only enabling normal operations on the mouse 11, but also enabling normal access to the storage unit 111, and the procedure is finished.

When the storage unit 111 is unlocked, namely when the mouse 11 is in a normal operation state, in step S26, the microcontroller 113 directly transmits the input signals to the computer system 10 through the interface 110 for normal operations, and the procedure is finished.

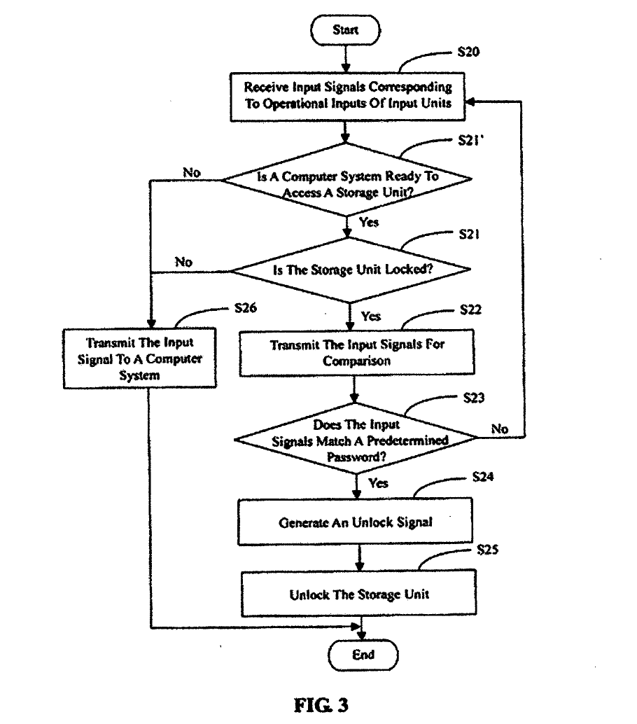

FIG. 3 is a flowchart of a second preferred method for unlocking the storage unit 111 of the input device 11 (i.e., the mouse 11) of FIG. 1. The steps of this flowchart are the same as those of FIG. 2, except for an additional step S21′, the microcontroller 113 detects whether the computer system 10 is ready to access the storage unit 111, that is, the microcontroller 113 detects whether the coordinate of the current movement of the mouse 11 corresponds to the coordinate of the storage unit 111. In particular, in step S21′, if the computer system 10 is ready to access the storage unit 111, the procedure goes to step S21. Otherwise, the procedure goes back to step S20.

Although the present invention has been specifically described on the basis of a preferred embodiment and preferred methods thereof, the invention is not to be construed as being limited thereto. Various changes or modifications may be made to the embodiment and method without departing from the scope and spirit of the invention.

What is claimed is:

1. An input device comprising:
a coordinate output circuit for generating coordinate inputs;
a plurality of input units for generating operational inputs; a storage unit for storing information, wherein the storage unit is not allowable for access when locked; and
a microcontroller for outputting the coordinate inputs from the coordinate output circuit to a computer system connected thereto, the microcontroller comprising:
a password comparing module, for comparing the operational inputs with a predetermined password, and for generating an unlock signal if the operational inputs match the predetermined password; and
an unlocking module electrically connected to the password comparing module and configured for unlocking the storage unit in response to the generation of the unlock signal, thereby enabling the computer system to access the information of the storage unit.

2. The input device according to claim 1, wherein the input units comprise a left button, a middle button, and a right button.

3. The input device according to claim 2, wherein the microcontroller further comprises a lock state controlling module for receiving the operational inputs from the input units if the storage unit is locked, and transmitting the operational inputs to the password comparing module.

4. The input device according to claim 3, wherein the microcontroller directly outputs the operational inputs from the input units to the computer system, if the storage unit is unlocked.

5. The input device according to claim 2, wherein the microcontroller further comprises a lock state controlling module for receiving the input signals if the storage unit is locked, and for transmitting the input signals to the password comparing module if the coordinate inputs match a coordinate of the storage unit.

6. The input device according to claim 5, wherein the microcontroller directly outputs the operational inputs to the computer system if the storage unit is unlocked.

7. The input device according to claim 5, wherein the microcontroller further directly outputs the operational inputs to the computer system if the storage unit is locked and the coordinate inputs do not match the coordinate of the storage unit.

8. A method used in an input device, wherein the input device has a storage unit, a coordinate output circuit for generating coordinate inputs, and a plurality of input units for generating operational inputs, the method comprising the steps of:
outputting the coordinate inputs from the coordinate output circuit to a computer system connected thereto;
comparing the operational inputs with a predetermined password if the storage unit is locked;
generating an unlock signal if the operational inputs match the predetermined password; and
unlocking the locked storage unit according to the unlock signal thereby enabling the computer system to access the storage unit.

9. The method according to claim 8, further comprising the step of:
directly outputting the operational inputs to the computer system if the storage unit is unlocked thereby allowing for access.

10. A method used in an input device, wherein the input device has a storage unit, a coordinate output circuit for generating coordinate inputs, and a plurality of input units for generating operational inputs, the method comprising the steps of:
outputting the coordinate inputs from the coordinate output circuit to a computer system connected thereto;
comparing the operational inputs with a predetermined password if the coordinate inputs match a coordinate of the storage unit and the storage unit is locked;
generating an unlock signal if the operational inputs match the predetermined password; and
unlocking the locked storage unit according to the unlock signal thereby enabling the computer system to access the storage unit.

11. The method according to claim 10, further comprising the step of:
directly outputting the operational inputs to the computer system if the storage unit is unlocked.

12. The method according to claim 10, further comprising the step of:
directly outputting the operational inputs to the computer system if the storage unit is locked and the coordinate inputs do not match the coordinate of the storage unit.
